(19) United States
(12) Patent Application Publication
(10) Pub. No.: US 2013/0139433 A1
(43) Pub. Date: Jun. 6, 2013

(54) STRUCTURE FOR CREATING HOUSINGS FOR SETTING TREES INTO THE GROUND AND METHOD FOR SETTING TRESS INTO THE GROUND

(71) Applicant: Pontarolo Engineering SPA, S. Vito al Tagliamento (PN) (IT)

(72) Inventors: Valerio PONTAROLO, Vito al Tagliamento (PN) (IT); Luca PONTAROLO, Vito al Tagliamento (PN) (IT)

(73) Assignee: PONTAROLO ENGINEERING SPA, S. Vito al Tagliamento (PN) (IT)

(21) Appl. No.: 13/707,214

(22) Filed: Dec. 6, 2012

(30) Foreign Application Priority Data
Dec. 6, 2011 (IT) PN2011A000081

(51) Int. Cl. A01G 13/00

(52) U.S. Cl. CPC A01G 13/00
USPC 47/32.6; 47/32.4

(57) ABSTRACT

A structure for creating housings for setting trees into the ground includes a plurality of modular elements (2), each one having an upper face (21) and support legs (22), the elements being associable with one another so as to obtain an upper surface (P, M), which is substantially continuous, and a lower volume (V), which is substantially empty. Tubular extensions (24), which at least partially cover the legs (22), according to their length determine the depth of the housing and hence the dimension of the volume (V). The tubular extensions are held in position, before the subsequent positioning of the modular elements, by a framework, which is provided with supports (32) adapted to be inserted into the upper mouth of the tubular extensions.

This application claims benefit of Serial No. PN2011A000081, filed 6 Dec. 2011 in Italy and which application is incorporated herein by reference. To the extent appropriate, a claim of priority is made to the above disclosed application.

### BACKGROUND

The present invention relates to a structure for creating housings for setting trees into the ground and to a method for setting trees into the ground.

In particular, the present invention relates to a structure for creating housings for setting trees into road surfaces such as, for example, pavements, squares, boulevards, which are generally covered with asphalt or concrete, and which generally do not show any opencast soil, which is necessary for planting a tree.

Trees are normally planted into road surfaces by making a hole or an opening in the road surface itself, so as to remove the road surface material and gain access to the underlying soil, into which the roots of the tree will then be placed.

Everything is then covered again by restoring the road surface, possibly leaving uncovered a circular area around the trunk of the tree, where the soil will remain visible. In drivable places, this area is often very small and insufficient to ensure proper tree vitality. In addition, as the tree grows, the roots will cause cracks in the covered areas and waves on the road surface, which may even hinder the practicability of the areas near the tree.

### SUMMARY

The object of the present invention is to overcome such drawbacks by providing a structure for creating housings for setting trees into the ground, which can create an underground region that can be filled with soil, where tree roots will be able to grow freely. Notwithstanding this, said region is then covered again to form the road or pavement surface, while at the same time preserving an underground vital space for the nourishment and expansion of the roots of the tree. Furthermore, this substantially prevents the roots from breaking or damaging the road surface.

Patent IT1288881 filed in the name of the same Applicant describes a modular floor support and aeration element to be applied for the purpose of insulating floors from the underlying soil. Said modular element has an upper face and support legs. Such elements can be coupled to one another to create a continuous structure, i.e. a plane onto which a concrete layer is then cast. Underneath the upper face, a free space is maintained between the legs where air is allowed to circulate, thus contributing to preventing moisture from penetrating into the floor that will then be laid onto the concrete layer.

The Applicant has perceived that such modular elements and other elements of the same kind described in patents 1T1292348 and 1T1379439 can be used for creating a housing under a road surface, into which soil and other materials suitable for planting trees can be placed.

### BRIEF DESCRIPTION OF THE DRAWINGS

The features and advantages of the structure according to the present invention will become more apparent from the following explanatory and non-limiting description of one embodiment thereof with reference to the annexed drawings, wherein:

FIG. 1 shows a sectional side view of the structure according to a first embodiment of the present invention;

FIG. 2 shows a plan view of the structure of FIG. 1, before the support concrete is cast onto it and the road surface is restored;

FIG. 3 shows a framework which is formed prior to laying the modular elements of the structure according to an embodiment of the present invention;

FIG. 4 shows an element of the framework of FIG. 3 according to an embodiment of the present invention;

FIGS. 5a and 5b show a framework element according to a further embodiment of the present invention;

FIG. 6 shows a framework obtained by using the elements of FIGS. 5a and 5b;

FIGS. 7a-7c show a detail of the coupling between the tubular extensions and the framework elements.

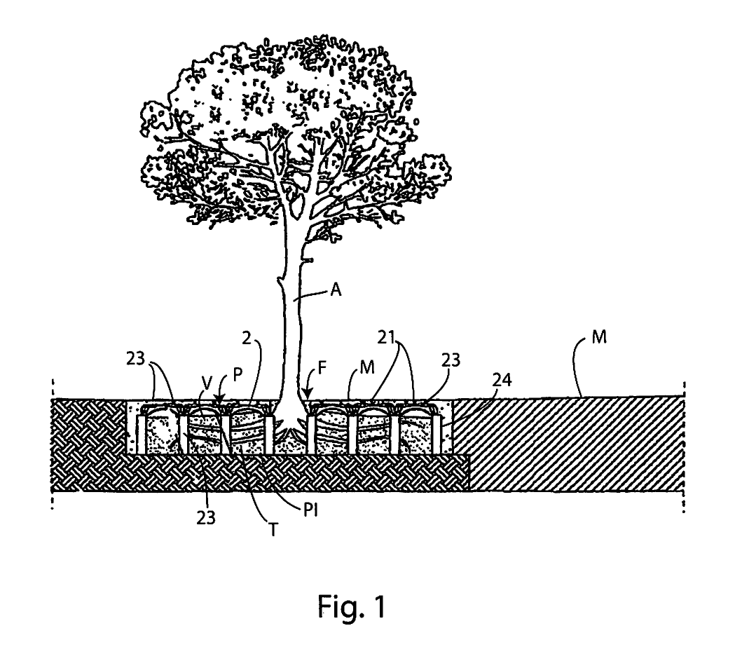

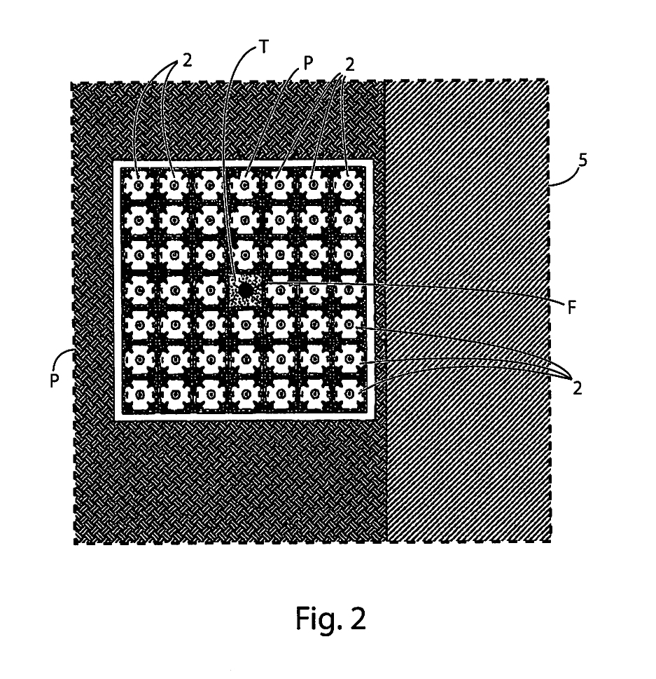

### DETAILED DESCRIPTION

With reference to the above-mentioned drawings, the structure according to the present invention comprises a plurality of modular elements 2, each one comprising an upper face 21 and support legs 22. Said elements are associable with one another to obtain a (flat or arched) surface P, which is substantially continuous, and an empty lower volume V. Said upper face is preferably square or rectangular, but it may have a different shape so long as it is suitable for creating said surface P. Said element may, for example, be made of plastic, expanded plastic, wood, reinforced concrete or iron.

Legs 22 are preferably so shaped as to be coupled to the legs of the adjacent modular element in the structure.

In a central portion of the structure, the absence of at least one element 2 or a part thereof determines the creation of a through opening F, which establishes a communication between volume V and the area above surface P. Through said opening, the trunk of tree A can be inserted. Volume V is filled with loam soil or another compatible material suited for the nourishment and growth of the tree.

On surface P, it is possible to reconstruct road surface M. In addition, according to a feature of the present invention, the structure may comprise a plurality of holes 23, obtained above the modular elements and creating a draining slab, thus allowing water to pass through the reconstructed road surface and reach the underlying loam soil.

The modular elements are provided with tubular extensions 24, which at least partially cover legs 22, which, according to their length, determine the depth of the housing and hence the dimension of volume V. Concrete or another suitable material can be inserted into the extensions, so as to firmly constrain the legs of adjacent modular elements 2 to each other. Also, said tubular extensions filled with material form “small pillars” that determine the load-carrying capacity of the structure, which must be able to withstand the weight of the road surface and of anything that may pass on it.

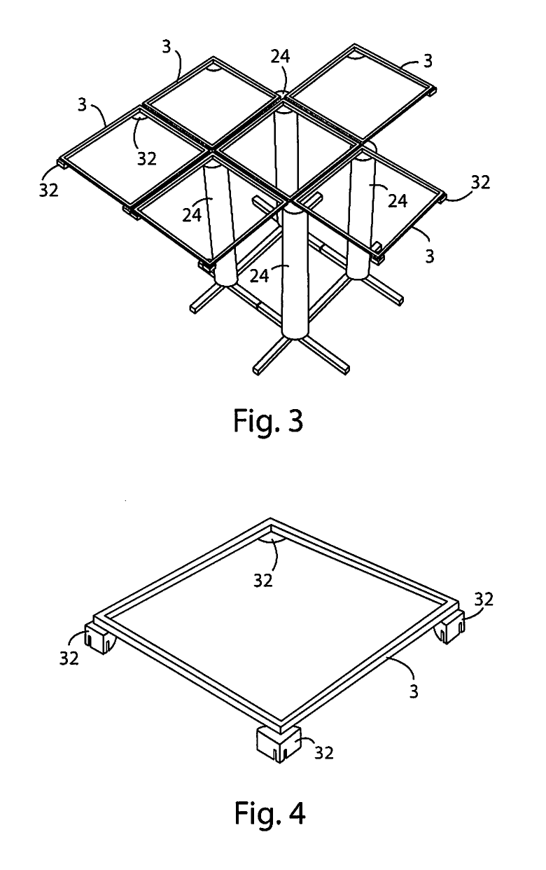

Such tubular extensions are inserted into the excavation before modular elements 2. They are held in the operating position (i.e. substantially vertical) by a framework made up of frame elements which, in the embodiment of the invention shown in FIGS. 3 and 4, are square or rectangular framework frames 3 arranged adjacent to one another, substantially in a chessboard fashion. The frames rest on the upper ends of the tubular extensions, thereby holding the latter in the predetermined position.

The dimensions of said frames match the size of upper face 21 of modules 2.

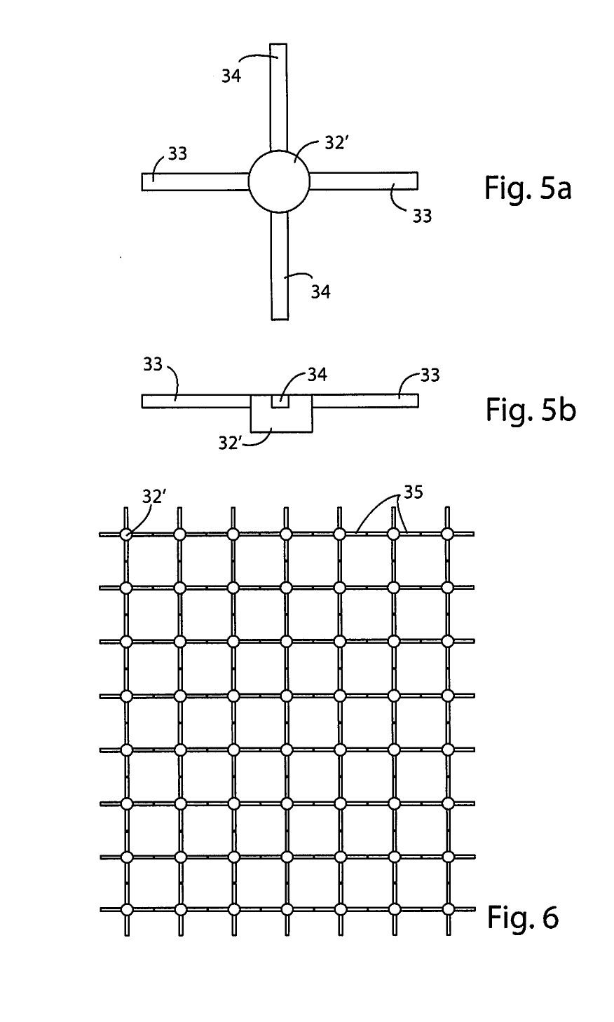

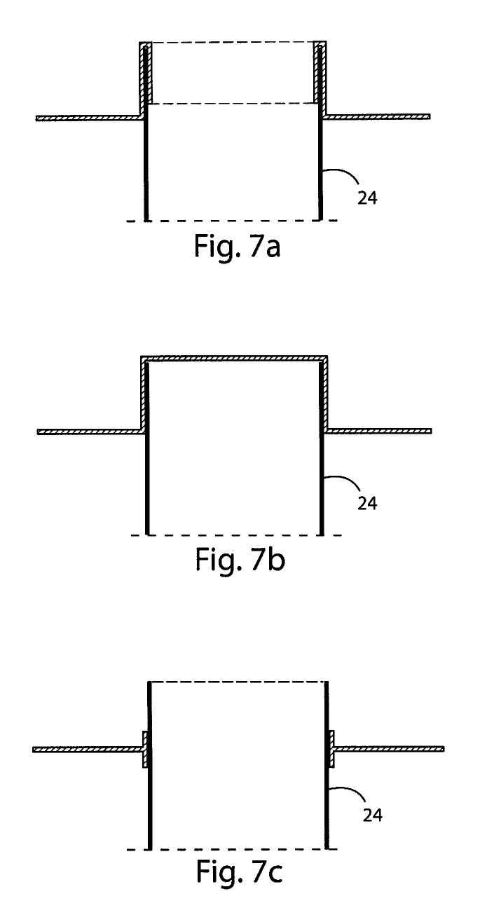

Said framework frames 3 essentially comprise a quadrangular crown 31 having at each angle a support 32 adapted to be inserted into the upper mouth of said tubular extensions. The shape of said support 32 is such as to facilitate its insertion into the tubular element, even when there are four associated supports as shown in FIG. 4. In fact, in the embodiment shown in FIGS. 3 and 4, the supports consist of 90° circular sectors, so as to obtain a cylindrical solid when four frame are joined together in a square arrangement. Said cylindrical solid is adequately sized to be easily inserted into the tubular extension, while also acting as a plug for the upper opening of the extension. In a further embodiment, the tubular extension may have a quadrangular cross-section. According to the embodiment shown in FIGS. 5 and 6, the framework elements have a substantially cross-shaped structure, wherein supports 32′ are associated with said tubular extensions and with respective limbs 33 and 34 of said cross. Said limbs are provided with constraining means 35 for creating a constraint to the limbs of a similar cross, so as to form a framework like the one shown in FIG. 6.

In other embodiments, the framework is made up of cross-shaped or quadrangular-frame structures, wherein the supports to be associated with the tubular extensions are hooks. Said hooks may be of the type that engages in a “U” fashion into the upper tubular wall. The upper opening of tubular extensions 24 may be, without distinction, either closed or left open by the frame according to the present invention.

Furthermore, each support may have additional grooves, seats and protuberances adapted to facilitate the engagement between the frames and the tubular extensions.

After the extensions and the frameworks have been laid, the excavation is filled with soil and then modules 2 are laid. Once modules 2 have been laid in position, concrete is cast which, when hardened, will support road surface M.

The method for setting a tree into the ground is carried out as follows.

The first step comprises forming a lower setting plane PI, e.g. by making a sufficiently large excavation. Subsequently, the tubular extensions are positioned and the framework is constructed thereon by positioning crowns 3. Once the extensions have been secured, the excavation can be filled with loam soil T or with the desired material.

After the excavation has been filled, the framework can be removed and replaced with modular elements 2.

On said modular elements, concrete or any other material suitable for supporting the road surface is then cast.

Advantageously, the step of laying the modular elements includes creating the opening for inserting the trunk of the tree.

This can be achieved through the absence of at least one element in the desired position, in the area corresponding to the aforementioned root housing, or by subsequently removing, e.g. by breaking or coring upper plane 21, at least one of the already positioned elements and removing the concrete.

The tree is then positioned by inserting it through said opening.

By so doing, it is possible to restore the road surface very quickly, in that both the filling of volume V and the positioning of the tree can be done at a later time, even after having formed the housing. While the road surface can be restored immediately after having made the excavation, laid the modules and cast the concrete.

As an alternative, the tree may be inserted into the excavation prior to laying the modules, after having removed the framework and filled the setting plane with soil.

According to a further alternative, the excavation is made around an existing tree, by excavating between the roots and cutting them as necessary, in order to be able to position tubular elements 24 and lay the modular elements.

Volume V has suitable dimensions for ensuring a proper nourishment of the tree and, depending on the type of plant to be set into the ground, one can choose the number and composition of the modular elements to be positioned (e.g. to form a square or a rectangle). In addition, one can change the length of tubular extensions 24 according to the required height to be filled with loam soil or another suitable material.

The setting plane may be laterally delimited, in order to prevent the concrete from entering empty volume V that must be filled with loam soil, by using known closing elements (not shown), such as wooden or plastic panels, etc. One suitable closing element is described in patent U.S. Pat. No. 6,941,705.

1. A structure for creating housings for setting trees into the ground, comprising
a plurality of modular elements, each modular element comprising an upper face and support legs, said elements being associable with one another so as to obtain an upper surface, which is substantially continuous, and a lower volume, which is substantially empty;
tubular extensions, which at least partially cover the legs, which, according to their length, determine the depth of the housing and hence the dimension of the volume
wherein said tubular extensions are held in position, before subsequent positioning of said modular elements, by a framework, which is provided with supports adapted to be inserted into an upper mouth of the tubular extensions;
wherein a roadway is reconstructed on said surface, except for one or more zones where a through opening is obtained, which establishes a communication between the volume and the area above the surface, and through which the lower portion of the trunk of the tree is inserted; and
wherein the volume is filled with loam soil or with an appropriate material for nourishment of said tree.

2. The structure according to claim 1, wherein the legs are shaped to be coupled with legs of adjacent modular element.

3. The structure according to claim 1, comprising a plurality of holes, obtained above the modular elements and creating a draining slab, thus allowing water to pass through a reconstructed road surface and reach underlying loam soil.

4. The structure according to claim 1, wherein the framework comprises frames having a substantially quadrangular shape and dimensions corresponding to a size of the upper face of the modules.

5. The structure according to claim 4, wherein said framework frames substantially comprise a quadrangular crown having at each angle one of said supports adapted to be inserted into the upper mouth of said tubular extensions.

6. The structure according to claim 5, wherein the supports comprise 90° circular sectors, to obtain a cylindrical solid when four frames are joined together in a square arrangement.

7. The structure according to claim 1, wherein the framework comprises a substantially cross-shaped structure, at the center of which are supports associated with said tubular extensions, respective limbs of said cross being provided with constraining means for creating a constraint to the limbs of a similar cross.

8. A method for setting trees, shrubs, plants or the like into a road surface, comprising the following steps:
forming a lower setting plane, which is sufficiently wide;
positioning a plurality of tubular extensions on said lower setting plane;
forming a framework provided with supports, adapted to be inserted into an upper mouth of the tubular extensions, to hold said extensions in a predetermined position, a filling volume being created under said framework,
filling said filling volume with loam soil or with desired material, except for at least one housing for roots of at least one tree;
removing the framework and positioning a plurality of modular elements, each modular element comprising an upper face and support legs, adjacent to one another, by inserting each leg into said extensions to obtain an upper surface which is substantially continuous;
casting concrete or any other material adapted to restore the road surface; and
creating an opening in the upper surface, in a position corresponding to said housing, for inserting the lower part of a trunk of the tree, positioning the tree by inserting the tree into said opening.

9. The method according to claim 8, wherein said step of creating the opening is obtained through a absence of at least one modular element in a desired position.

10. The method according to claim 8, wherein said step of creating the opening is obtained by removing, through breaking or coring of the upper face, of at least one of the positioned elements and by removing the concrete covering the at least one of the positioned elements.

11. The structure according to claim 1, wherein upper opening of the tubular extensions may be either closed by the framework or left open.
